(19) United States
(12) Patent Application Publication
(10) Pub. No.: US 2007/0098913 A1
(43) Pub. Date: May 3, 2007

(54) Method for coating turbine engine components with metal alloys using high velocity mixed elemental metals

(75) Inventors: Derek Raybould, Denville, NJ (US); Paul Chipko, Blairstown, NJ (US); Siu-Ching D. Lui, Watchung, NJ (US); Margaret M. Floyd, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/261,068

(22) Filed: Oct. 27, 2005

(51) Int. Cl. B05D 1/08; H05H 1/24

(52) U.S. Cl. 427/446; 427/569

(57) ABSTRACT

A plurality of powders is admixed to form a substantially homogenous powder mixture comprising each of the alloy elements. At least one of the powders consists essentially of a substantially pure elemental metal. The substantially homogenous powder mixture is cold gas-dynamic sprayed on the substrate to form a coating of the alloy elements. The coating is then heated until the alloy elements inter-diffuse and form the alloy. In an exemplary embodiment, the substantially homogenous powder mixture includes stoichiometric amounts of each of the alloy elements, and each of the powders consists essentially of a substantially pure form of one of the alloy elements.

### TECHNICAL FIELD

The present invention relates to methods for applying dense and highly uniform metal alloy coatings onto articles such as gas turbine engine components and, more particularly, to methods for coating at temperatures below the melting points of such alloys.

### BACKGROUND

Cold gas-dynamic spraying (hereinafter “cold spraying”) is a technique that is sometimes employed to form coatings of various materials on a substrate. In general, a cold spraying system uses a pressurized carrier gas to accelerate particles through a supersonic nozzle and toward a targeted surface. The cold spraying process is referred to as a “cold gas” process because the particles are mixed and sprayed at a temperature that is well below their melting point, and the particles are near ambient temperature when they impact with the targeted surface. Converted kinetic energy, rather than a high particle temperature, causes the particles to plastically deform, which in turn causes the particles to form a bond with the targeted surface. Bonding to the component surface occurs as a solid state process with insufficient thermal energy to transition the solid powders to molten droplets. Cold spraying techniques can therefore produce a wear or corrosion-resistant coating that strengthens and protects the component using a variety of materials that can not be applied using techniques that expose the materials and coatings to high temperatures.

A variety of different systems and implementations can be used to perform a cold spraying process. For example, U.S. Pat. No. 5,302,414, entitled “Gas-Dynamic Spraying Method for Applying a Coating” describes an apparatus designed to accelerate to supersonic speed materials having a particle size of between 5 to about 50 microns. The particles are sprayed from a nozzle at a velocity ranging between 300 and 1200 m/s. Heat is applied to the carrier gas to between about 300 and about 400° C., but expansion in the nozzle causes the spraying material to cool. The spraying material therefore returns to near ambient temperature by the time it reaches the targeted substrate surface.

When the sprayed particles impinge on the targeted substrate surface, the impact breaks up any oxide films on the particle and substrate surfaces as the particles bond to the substrate. Thus, cold spraying techniques prevent unwanted oxidation of the substrate or powder, and thereby produce a cleaner coating than many other processes. Such techniques also enable the formation of non-equilibrium coatings. More specifically, since the sprayed materials are not heated or otherwise caused to react with each other or with the substrate, coatings can be produced that are not producible using other techniques.

In contrast to cold spraying, thermal spraying processes include heating methods to bring at least some of the spray material to a melting point, thereby producing a strong and uniform coating. Some thermal spraying processes also utilize a plasma to ionize the sprayed materials or to assist in changing the sprayed materials from solid phase to liquid or gas phase. Melted spraying particles produce liquid splats that land on a targeted substrate surface and bond thereto. Some thermal spraying techniques only supply sufficient heat to melt a fraction of the spraying material particles, and consequently only cause surface melting to occur.

Thermal spraying is not a viable method for applying coatings of alloys having relatively high melting temperatures to many substrates since the high temperature liquid or particles may react with or disrupt the substrate surface and perhaps lower its strength. Cold spraying is sometimes a preferred spraying method because it enables the sprayed materials to bond with a substrate at a relatively low temperature, and to form coatings of unique alloys that are not formable using thermal spraying techniques. The coating materials that are sprayed using the cold gas-dynamic spraying process typically only incur a net gain of about 100° C. with respect to the ambient temperature. Plastic deformation facilitates metallurgical bonding of sprayed particles to the substrate. Consequently, metallurgical reactions between the sprayed powder and the component surface are minimized. Further, since the sprayed particles are kept well below their melting temperatures, they are not very susceptible to oxidation or other reactions.

Although many materials can be applied to a substrate using cold spraying techniques, it may be relatively costly to form a coating from some alloys that have particularly high strength or hardness. For example, powders of MCrAlY alloys such as NiCrAlY, FeCrAlY, and CoCrAlY, and powders of many superalloys require high gas pressures or velocities to impact with a substrate at a sufficient speed to plastically deform and create a dense coating. Powders of such alloys and superalloys may be costly, particularly at particle sizes and size distributions that enable a simple and effective cold spraying process. In addition, powders of such alloys and superalloys require high impact velocities if they are to sufficiently bond to the substrate and form a dense coating. Creating supersonic gas velocities may require the use of helium gas as a driver, rather than less expensive gases such as air or nitrogen.

Hence, there is a need for a spraying method that is capable of efficiently and cost-effectively producing a wear and oxidation-resistant coating from alloy and superalloy materials that have high strength or hardness. More particularly, a need exists for producing such coatings using relatively inexpensive carrier gases and coating metal materials. There is also a need for a spraying method by which such materials can be uniformly and thoroughly applied at temperatures well below their melting points.

### BRIEF SUMMARY

The present invention provides a method for coating a substrate with an alloy comprising a plurality of elements. A plurality of powders is admixed to form a substantially homogenous powder mixture comprising each of the alloy elements. At least one of the powders consists essentially of a substantially pure elemental metal. The substantially homogenous powder mixture is cold gas-dynamic sprayed on the substrate to form a coating of the alloy elements. The coating is then heated until the alloy elements inter-diffuse and form the alloy. In an exemplary embodiment, the substantially homogenous powder mixture includes stoichiometric amounts of each of the alloy elements, and each of the powders consists essentially of a substantially pure form of one of the alloy elements.

Other independent features and advantages of the preferred methods will become apparent from the following detailed description, taken in conjunction with the accompanying drawing which illustrates, by way of example, the principles of the invention.

### BRIEF DESCRIPTION OF THE DRAWING

FIG. 1 is a schematic view of a cold spraying apparatus;

FIG. 2 is a flow chart depicting a first exemplary method for coating a substrate using a mixture of elemental metal powders;

FIG. 3 is a flow chart depicting a second exemplary method for coating a substrate using a mixture of elemental metal powders;

FIG. 4 is a flow chart depicting a third exemplary method for coating a substrate using a mixture of elemental metal powders;

FIG. 5 is a backscattered electron image of a cold sprayed coating from a powder mixture of 90% aluminum and 10% chromium from a scanning electron microscope at 100× magnification; and

FIG. 6 is a scanning electron image of the cold sprayed coating depicted in FIG. 5 from a scanning electron microscope at 100× magnification after heat treating the coating at 600° C. for twelve hours.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

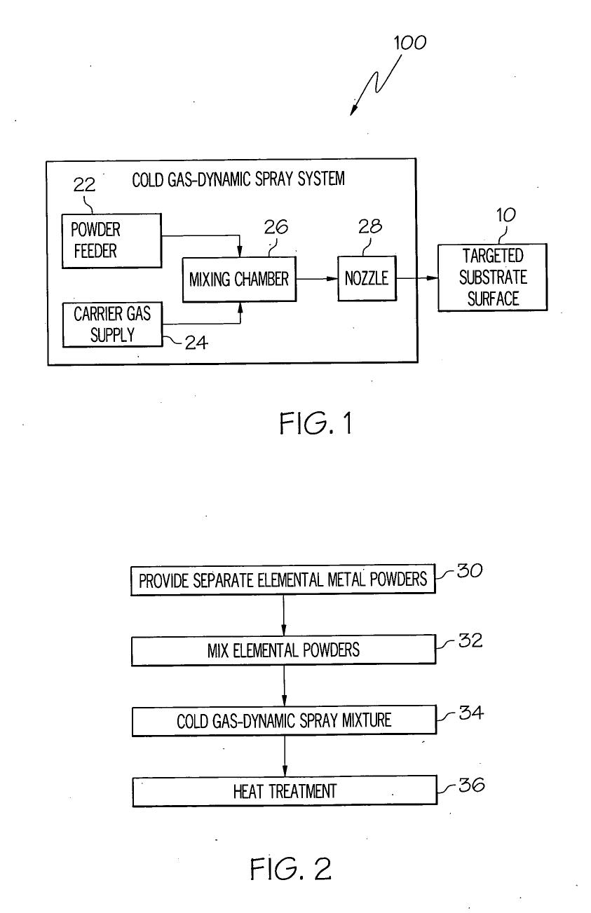

Turning now to FIG. 1, an exemplary cold spraying system 100 is illustrated diagrammatically. The system 100 is illustrated as a general scheme, and additional features and components can be implemented into the system 100 as necessary. The main components of the cold spraying system 100 include a powder feeder 22 for providing powder materials, a carrier gas supply 24 for heating and accelerating powder materials at temperatures of about 300 to 400° C., a mixing chamber 26 and a convergent-divergent nozzle 28. In general, the system 100 transports the metal powder mixtures with a suitable pressurized gas to the mixing chamber 26. The particles are accelerated by the pressurized carrier gas such as air, helium or nitrogen, through the specially designed supersonic nozzle 28 and directed toward a targeted surface 10 to form a dense and uniform coating.

As previously discussed, some alloys and superalloys are difficult or costly to apply by cold spraying due to their hardness, or inefficiencies associated with optimizing their spraying velocities and/or particle sizes and distributions. One exemplary method of the present invention includes admixing two or more elemental metal powders together and cold spraying the mixture onto a targeted substrate. FIG. 2 is a block diagram depicting this type of method. In step 30, separate elemental metal powders are provided. For example, to form a cold sprayed MCrAlY coating, wherein M is a metal such as Co, Ni, and Fe, substantially pure powders of elemental metals of M, Cr, Al, and Y are separately provided instead of an MCrAlY alloy powder. According to other examples, as few as two elemental metal powders may be selected to form a cold sprayed coating of a simple two metal alloy, or a substantially greater number of metal and/or nonmetal elemental powders may be provided to form a cold sprayed coating of a more complex alloy such as a superalloy. The terms “alloy” and “superalloy” include both fully reacted compounds and solid solutions in which the elemental powders are inter-diffused to form a crystalline material with atoms of some components replacing atoms of another component in its normal crystal lattice.

To optimize the coating and the cold spraying method, additional powder characteristics may be selected by taking into consideration such factors as a predetermined average particle size and a predetermined particle size distribution for one or more of the elemental metals. In many cases, finer elemental metal powders and elemental powders with specific particle size distributions may be obtained more cheaply than finer alloy metal powders, making the overall method more economical. Further, smaller elemental metal particles will generally undergo plastic deformation upon impact with a surface at a velocity that is lower than that required for larger metal alloy or superalloy particles. Although helium is a carrier gas capable of spraying relatively large particles at supersonic velocities sufficient to cause the large particles to plastically deform upon impact with a substrate surface, the smaller elemental metal particles can be sprayed at a sufficient velocity using helium at a lower pressure flow, or using cheaper carrier gases such as air and nitrogen.

Next, the elemental metal powders are mixed together as step 32. Mixing the metal powders may be performed using various hand or machine mixing methods. By using separate elemental metal powders as mixture components, the subsequently cold sprayed alloy coating can be tailored to have particular concentrations for each metal. For instance, a coating of a compound having 90% Al and 10% Cr may be ideal for many applications, and a powder having AlCr particles at such concentrations may be readily obtainable. However, if it is desirable to increase or decrease the Cr concentration for a particular application, it may be costly to obtain powders for one or more powders having the desired Cr concentrations. In contrast, the Cr concentration can be readily modified by adding or subtracting amounts of Cr to the mixture of elemental Al and Cr.

After mixing the elemental metal powders, the system 100 from FIG. 1 transports the mixture with a suitable pressurized gas to the mixing chamber 26, and the mixture is accelerated by the pressurized carrier gas through the nozzle 28 toward a targeted surface 10 as step 34. The elemental metals in the mixture bond with the targeted surface and form a dense coating, although little or no diffusion occurs between the elements.

After spraying, a heat treatment is performed as step 36 to cause the separate metal elements to diffuse and form the desired alloy or superalloy with a substantially uniform microstructure and composition. An exemplary heat treatment includes one or more temperature increasing periods, with each increase followed by a holding period during which a particular temperature is held for a sufficient amount of time for the metals to inter-diffuse. For example, a heat treatment method for a coating of metals having different melting points may include a temperature increasing period during which the coating temperature is raised at a specified rate until the temperature reaches a first point, which is a predetermined percentage (less than 100% K) of the melting temperature for the metal having the lowest melting point. For example, in an exemplary method the coating temperature is raised to at least least 25° C. below the lowest melting temperature. The temperature is held at the first point for a first holding period that allows the metal having the lowest melting point to inter-diffuse with the other metals. An exemplary holding period is over 15 minutes, and may be over 1 hour in some embodiments. The first holding period is followed by another temperature increasing period that ends when the coating temperature reaches a second point, which is a predetermined percentage (less than 100% K) of the melting temperature for the metal having the second lowest melting point. The temperature is held at the second point for a second holding period that is maintained to allow the metal having the second lowest melting point to inter-diffuse with the other metals. Temperature increasing and holding periods are continued until the metals are able to inter-diffuse and form a uniform coating. For other exemplary heat treatments, it may not be necessary to include a plurality of holding periods and temperature increasing periods as long as the metals are able to sufficiently inter-diffuse. For any of the heat treatments, the temperatures are always preferably significantly below the melting point of any of the elemental metals to avoid oxidation of the coating or a reaction between the substrate and any of the cold sprayed metals.

Using the above method, a coating having a uniform microstructure and composition is formed due to surprisingly little or no separation of the admixed elemental metals. The mixture's maintained homogeneity is particularly remarkable since each metal has a different density, particle size and shape, and particularly since the mixture is shifted and may be subject to separation when being fed into the mixing chamber 26 and through the supersonic nozzle 28.

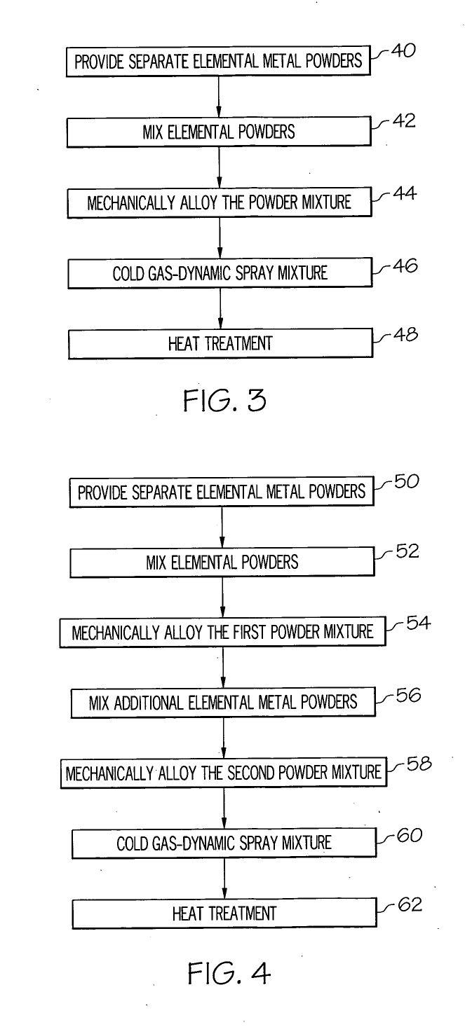

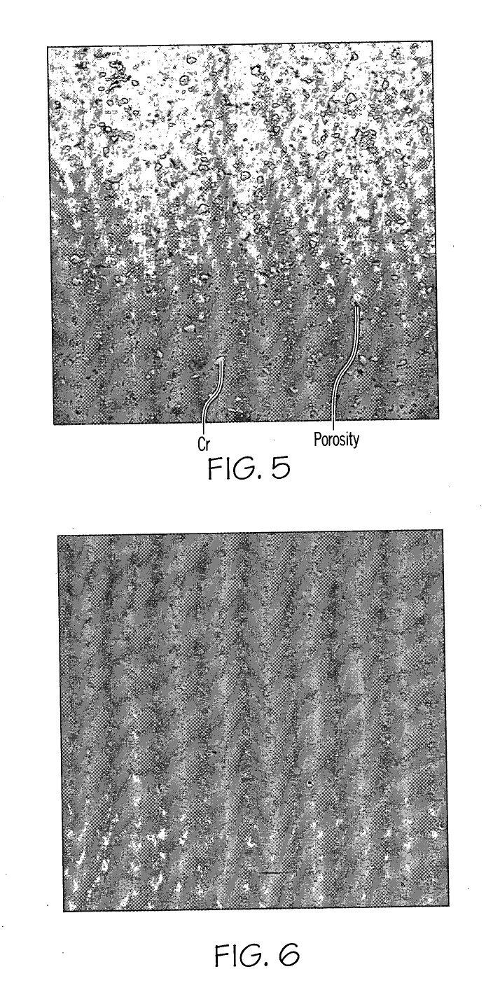

FIGS. 5 is a backscattered electron image of a cold sprayed coating from a powder mixture of 90% aluminum and 10% chromium from a scanning electron microscope at 100× magnification. The image represents the coating formed after performing the method outlined in FIG. 3, but prior to performing the heat treatment step 48. Both the aluminum and chromium powders had particle sizes less than 40 microns, and the mixtures were mixed by hand shaking the combined metals, followed by ball milling the mixture. The image of FIG. 5 reveals that the cold sprayed coating is still a mixture of substantially pure aluminum and chromium powders. The coating is surprisingly dense, having less than 2% porosity despite there being no apparent diffusion between the sprayed particles.

FIG. 6 is a scanning electron image of the cold sprayed coating depicted in FIG. 5 from a scanning electron microscope at 100× magnification after heat treating the coating at 600° C. for twelve hours as step 48 of the method outlined in FIG. 4. Following the heat treatment, the particles were uniformly distributed and inter-diffused to form a reacted AlCr coating. The coating porosity was reduced to less than 0.5%.

FIG. 3 is a block diagram depicting an exemplary method that includes the step 40 of providing separate elemental powders, step 42 of mixing the powders, step 46 of cold spraying the mixture, and step 48 of performing a heat treatment, as previously described with reference to FIG. 2. The method outlined in FIG. 3 further includes mechanically alloying the powder mixture as step 44 prior to cold spraying the mixture in order to prevent separation of the mixture during storage. Mechanically alloying the mixture causes the elemental metals to stick together so they do not separate, although viewing the mixture with a scanning electron microscope reveals distinct separate elemental metals rather than inter-diffused metals or compounds. One way to mechanically alloy the mixture is to ball roll the combined elemental metal powders. Ball milling is a low cost procedure that results in a substantially homogenous composition of unreacted metals. Also, some mixtures of elemental metals may need to be stored for an extended period before being cold sprayed. Since particles having different sizes and densities may separate over time, additional steps may be taken to keep the mixture substantially homogenous during storage.

In addition to the cost and efficiency-related benefits resulting from the use of elemental metal powders as starting materials instead of metal alloy and superalloy powders, elemental metal powders also add versatility to a coating method. For example, some areas of a turbine blade may need higher concentrations of some metals to provide additional hardness and strength, some areas may need higher concentrations of different metals such as Al to improve oxidation, and other areas may need higher concentrations of other metals such as Cr to improve corrosion resistance, although the alloys coating each of these areas may have very similar overall compositions. In order to efficiently coat different surfaces with similar but not identical alloys, a base mixture of elemental metal powders is prepared, and the base mixture is modified with additional elemental metal powders as needed. These additions maybe made while spraying the same part. Different locations on a part may therefore have different properties as required from the conditions they experience without the expense of carrying out multiple coatings operations and the risk in joining or overlapping different runs.

According to another embodiment, the base mixture comprises at least one powder of an alloy. The alloy powder particles may be mechanically alloyed, or they may be prealloyed particles from a procedure such as melting and atomization. At least one substantially pure elemental powder is then added to the base mixture. Combining the elemental powder with alloy particles makes the cold spray operation easier and more efficient. For instance, the addition of soft Al to a MCrAlY powder, either as an elemental powder or as a coating on the base alloy powder particles, reduces the velocity required to achieve a dense and well bonded coating, while also enabling the use of nitrogen rather then helium as a carrier gas.

FIG. 4 is a block diagram depicting an exemplary method that includes providing separate elemental metal powders as step 50, and mixing the elemental metal powders to form a base mixture as step 52. The base mixture is either mechanically alloyed or prealloyed to prevent separation of the metal powders until additional elemental metals are added as step 54. To adjust the composition of the base mixture as needed, additional amounts of some metals, or amounts of newly-introduced metals, are admixed into the base mixture as step 56 to make a modified mixture. The additional amounts may be admixed into the feed hopper of a cold spraying apparatus during spraying, or fed from at least one separate feed tube into the gas stream. If necessary, the modified mixture may be mechanically alloyed as step 58 before spraying. The modified mixture is then cold sprayed onto a targeted surface as step 60, and the coating is heat treated to allow the metals to inter-diffuse and react as step 62 to produce a dense and uniform coating.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method for coating a substrate with an alloy comprising a plurality of elements, the method comprising:
admixing a plurality of powders to form a substantially homogenous powder mixture comprising each of the alloy elements, at least one of the powders consisting essentially of a substantially pure elemental metal;
cold gas-dynamic spraying the substantially homogenous powder mixture on the substrate to form a coating of the alloy elements; and
heating the coating until the alloy elements inter-diffuse and form the alloy.

2. The method according to claim 1, wherein each of the powders consists essentially of a substantially pure elemental metal, and the substantially homogenous powder mixture comprises stoichiometric amounts of each of the alloy elements in a substantially pure elemental form.

3. The method according to claim 1, wherein at least one of the powders comprises pre-alloyed particles.

4. The method according to claim 3, wherein the pre-alloyed particles are coated with a layer of an elemental metal.

5. The method according to claim 1, wherein each of the alloy elements has a melting point, and heating the coating comprises heating below the melting temperature for the element having the lowest melting point.

6. The method according to claim 5, wherein heating the component comprises performing a plurality of temperature increasing periods during which the coating temperature is raised to at least first and second temperatures, and a plurality of temperature holding periods during which the coating temperature is maintained at least at the first and second temperatures, each of the at least first and second temperatures being below the melting temperature for the element having the lowest melting point.

7. The method according to claim 6, wherein one of the holding temperatures is maintained for at least 15 minutes at least 25° C. below the melt temperature for the element having the lowest melting point.

8. The method according to claim 1, wherein admixing the plurality of powders comprises hand mixing the plurality of powders.

9. The method according to claim 1, wherein admixing the plurality of powders comprises mechanically alloying the plurality of powders.

10. The method according to claim 1, wherein admixing a plurality of powders comprises:
preparing a substantially homogenous base mixture comprising some of the alloy elements;
mechanically alloying or prealloying the alloy elements in the base mixture; and
admixing at least one powder of an alloy or alloy element into the base mixture to produce the substantially homogenous powder mixture comprising each of the alloy elements.

11. The method according to claim 1, wherein admixing the at least one powder of an alloy or alloy element into the base mixture is performed while cold gas-dynamic spraying procedure.

12. The method according to claim 1, wherein the alloy is an MCrAlY alloy, wherein M is a metal.

13. A method for coating a substrate with an alloy comprising stoichiometric amounts of a plurality of elements, the method comprising:
admixing a plurality of powders to form a substantially homogenous powder mixture comprising the stoichiometric amounts of each of the alloy elements, each of the powders consisting essentially of a substantially pure form of one of the alloy elements;
cold gas-dynamic spraying the substantially homogenous powder mixture on the substrate to form a coating of the alloy elements; and
heating the coating until the alloy elements inter-diffuse and form the alloy.

14. The method according to claim 13, wherein each of the alloy elements has a melting point, and heating the coating comprises heating below the melting temperature for the element having the lowest melting point.

15. The method according to claim 14, wherein heating the component comprises performing a plurality of temperature increasing periods during which the coating temperature is raised to at least first and second temperatures, and a plurality of temperature holding periods during which the coating temperature is maintained at the at least first and second temperatures, each of the at least first and second temperatures being below the melting temperature for the element having the lowest melting point.

16. The method according to claim 15, wherein one of the holding temperatures is maintained for at least 15 minutes at least 25° C. below the melt temperature for the element having the lowest melting point.

17. The method according to claim 13, wherein admixing the plurality of powders comprises hand mixing the plurality of powders.

18. The method according to claim 13, wherein admixing the plurality of powders comprises mechanically alloying the plurality of powders.

19. The method according to claim 13, wherein admixing a plurality of powders comprises:
preparing a substantially homogenous base mixture comprising some of the alloy elements;
mechanically alloying the alloy elements in the base mixture; and
admixing at least one powder of a substantially pure element into the base mixture to produce the substantially homogenous powder mixture comprising each of the alloy elements.

20. The method according to claim 13, wherein the alloy is an MCrAlY alloy, wherein M is a metal.
